(19) United States
(12) Patent Application Publication
(10) Pub. No.: US 2014/0132748 A1
(43) Pub. Date: May 15, 2014

(54) SYSTEM WITH FIRST AND SECOND CONTROL DEVICES, AND METHOD FOR THE OPERATION THEREOF

(71) Applicant: Stephan Nufer, Erlangen (DE)

(72) Inventor: Stephan Nufer, Erlangen (DE)

(21) Appl. No.: 14/081,050

(22) Filed: Nov. 15, 2013

(30) Foreign Application Priority Data
Nov. 15, 2012 (DE) 102012220912.3

(51) Int. Cl. H04N 7/18

(52) U.S. Cl. CPC H04N 7/183
USPC 348/77

(57) ABSTRACT

In a system and operating method therefor, the system has a first computer associated with an implementation workstation and a second computer associated with an observation workstation, connected with the first computer via a communication connection. Result data of a number of processes that are to be displayed at the second computer are transferred to the second computer, and at least one item of status information indicating the status of a process is determined, transferred from the first computer to the second computer and is displayed for a user at the second computer simultaneously with the displayed result data of the process and/or another process.

### BACKGROUND OF THE INVENTION

1. Field of the Invention

The present invention concerns a method to operate a system that has a first computer associated with an implementation workstation, and a second computer associated with an observation workstation and connected with the first computer via a communication connection, wherein result data of multiple processes that are to be displayed are transferred to the second computer.

2. Description of the Prior Art

Multi-user systems are known with which one or more users work at an implementation workstation, for example at a specific device that produces different result data during successive processes. These processes can be a repetition of essentially the same process, for example an image acquisition or test, but it is also possible that a complete process has multiple sub-processes (steps). Other users who operate at a second computer and are interested in the result data (for example specific milestones/intermediate results) are consequently located at an observation workstation. The result data are transferred to this observation workstation via a communication connection so that the users at the observation workstation can view and suitably use the transferred data.

Radiological medical examinations—for example an examination with a magnetic resonance device or another image acquisition device—are a specific field of use that is discussed herein. These involve the examination of a patient from whom image data are acquired, particularly in the form of one or more image data sets. For example, in the case of magnetic resonance, an examination can include a series of different sequences that successively deliver image data. The examinations are implemented by specific operating personnel (for example a medical technician) at the image acquisition device, while radiologists at a finding workstation (as the observation workstation) view the image data, such as to make a check already during and before the end of an examination (data acquisition) as to whether it is necessary to repeat the acquisition of specific image data, for example due to movement artifacts or insufficient image quality.

It is known to execute an appropriate communication (necessary for a repetition, for example) between the operator of the image acquisition device and the assessing physician (in particular a radiologist) by directly speaking (shouting to a neighboring room, for example) or via a telephone call. This is explained in detail in an example.

For example, if contrast agent is administered in an examination, it is subsequently no longer possible to reacquire image data that were acquired before the administration of contrast agent. For this reason it is known for the operator to contact the radiologist responsible for the assessment of the images by telephoning/or directly speaking to him or her before the administration of the contrast agent, and asking the radiologist to view the image data, for example via a remote desktop connection or the like. The radiologist will require a repetition of the acquisition of the image data if, for example, the image quality is insufficient for assessment or if specific structures are not visible due to incorrectly placed acquisition regions (in particular image slices). If the radiologist accepts the image data, the examination continues and the contrast agent can be injected.

A second point in time at which an interaction exists between a radiologist and the operator of the image acquisition device is just before the end of the examination. Before the patient leaves the image acquisition device, the operator again contacts the radiologist (by telephoning/directly speaking) so that the radiologist is given an opportunity to arrange for the acquisition of additional image data, for example, in order to further examination a conspicuity or repeat specific image acquisitions, for example after the administration of contrast agent.

Overall, the communication between the radiologist at the finding workstation and the operator at the image acquisition workstation is useful in order to avoid an additional examination that might require the patient to make an appointment for another imaging session, and so as to more efficiently utilize the usage time of the image acquisition device.

Special assessment computer programs are known that can be used at finding workstations, for example the syngo.via program package distributed by Siemens AG. As described above, for this purpose the image data are sent to the second computer at the finding workstation so that the radiologist can assess already examined patients. Although embodiments are known in which scheduled patients that are presently being examined or should still be examined can be selected by the assessing radiologist, time is lost if patients are selected when no image data is available, and so no assessment can occur.

### SUMMARY OF THE INVENTION

The invention is therefore based on the object to provide improved information at the observation workstation with regard to ongoing procedures at the image acquisition site.

This object is achieved according to the invention in a method of the aforementioned type by determining at least one item of status information indicating the status of a process that is ongoing at the data acquisition site, and transferring this at least one item of status information to the second computer and display the status information there for a user simultaneously with displayed result data of the process and/or another process.

According to the invention, at least one item of status information concerning the directly observed process or an additional process (in particular temporally adjoining processes within a defined time interval, for example one day) is likewise also transferred to the second computer in addition to the result data, such that improved information is enabled for the observing person at the observation workstation. It is important that the status information is displayed to a user at the second computer simultaneously with displayed result data, so that the viewer can continuously make conclusions about the status of the different processes without interrupting his or her current observation task (in particular evaluation task). For example, the user at the second device can learn whether result data regarding a different process are already present, whether intermediate steps have concluded or are imminent, and the like. Improved information about the status of the processes at the first computer is thereby provided to the user at the second computer, with little effort by the participating persons, and up-to-date conclusions about currently observed processes and other processes are enabled.

The present invention can be used particularly advantageously in the field of medical image acquisition, wherein the observation workstation is a finding workstation and the implementation workstation is an image acquisition workstation with an image acquisition device. This is discussed in further detail in the following.

Naturally all cited processes are implemented automatically by the computers themselves without needing to interpose a mental step of a user, unless this is explicitly specified in the further embodiments for additional features to improve the subject matter of the invention.

In a further embodiment of the invention, the status information is determined by the first computer and/or a control device engaged in a communication connection with the first computer. For example, an implementation device at the implementation workstation, which is used to implement the process and determine the result data, can have a control device that determines the current status and relays it to the first computer, which communicates this in turn to the second computer. It is also possible for the first computer (which can itself be a control device of such an implementation device, in particular an image acquisition device) can itself determine the status information, which is the case if this is used anyway for central control of the process, in particular the image acquisition.

It is also advantageous for the status information to be determined continuously and to be transferred to the second computer at least upon the occurrence of a change of the status information. Processes that are to be executed at the implementation workstation are consequently continuously monitored with regard to their status. As soon as a change has occurred (for example if result data are present), or a step is concluded, or even a complete ending of the process occurs, this is consequently detected and corresponding status information is transferred to the second computer, at least given occurrence of a change of the status information. Current information is thus continuously generated and provided to the user at the second image acquisition device simultaneously with displayed result data.

As already noted, the process can have multiple steps, and status information pertaining to the current step and/or an action to be taken can be used. If the process (for example an examination of a patient with an image acquisition device) can be divided into different intermediate steps, the information at the second computer can be markedly improved by the status information also informing the viewer at the observation workstation about intermediate steps or specific actions to be taken. One example of such an action is the administration of a contrast agent, for example where a time until administration of the contrast agent can be transferred and displayed as status information, such that an observing or assessing radiologist recognizes how much time remains to him or her in order to repeat a preceding intermediate step for acquisition of image data without contrast agent, for example. The ending of the process is also frequently information of interest, in particular a time until the end of the process, since the observing person is then aware of how long he or she can still intervene (for example, can arrange the acquisition of additional image data of the patient and the like in the case of a medical image acquisition).

Specific trigger events, even in automated examination workflow, can lead to an updating of the status information, with the end of an image data acquisition step (in particular one running automatically) also generating updated status information simultaneously with a timer for an operator or a contrast agent injector, which updated status information is then transmitted to the second computer and displayed there (possibly due to the changes), so that the assessing person is made aware of the impending contrast agent administration.

As already noted, the method according to the invention can be advantageously used in the medical examination of patients with an image acquisition device. In this context, the observation workstation is a finding workstation, the implementation workstation is an image acquisition workstation and the process is the examination of a patient, wherein image data of a patient that are acquired by an image acquisition device at the image acquisition workstation are transferred to the computer of the finding workstation. Certain developments of the present invention are especially suited to such a medical context.

Thus, a list of patients to be examined in a defined time period (in particular one day) and/or a time period determined by a defined point in time, and/or a list of patients sent by the second computer, can be present at the first computer, with the status information for each patient of the list being determined and transferred. This means that data about the patient to be examined are present for a defined date or for a defined period of time (in particular a period of time in which a specific assessor is present at the second computer), and current information about the status of the various examinations is delivered continuously to the user at the second computer (thus at the finding workstation). This user can view this status information during the assessment of a specific patient because it has been displayed simultaneously with image data. In this way, particularly complete information is achieved that includes data (for example here an appointment schedule) present anyway at the first computer in order to establish the purpose for which the status information are required.

As already noted, the status information pertaining to the point in time of the implementation of the examination and/or the current implementation of the examination can preferably be used. Status information describing at least one step and/or an event within the examination of the patient—in particular status information pertaining to the administration of a contrast agent and/or the end of the examination—can be used. As emphasized with regard to the general discussion of the status information, times until specific events (such as the administration of the contrast agent and the end of the examination) are particularly important to the assessor since they have an effect on decision time periods in which a decision must be made as to whether an image data acquisition must be repeated (for example because the image quality is insufficient), or whether additional image data should be acquired (for example in order to be able to examine a lesion or other conspicuity in more detail). If the status information includes a time, the second computer can be configured to use this time to display a timer that indicates the time until the relevant event or the action, such that the user at the second computer is always currently informed, even when a current time is not always being transmitted as the status information.

In another embodiment of the invention, a user interface is provided, that includes index cards for the individual processes, for use in considering the result data at the second computer, and the status information is displayed in a tab of the index card of the process to which the status information pertains. Such index cards and tabs are typically used in order to be able to switch quickly between different processes (for example different patients) so that the corresponding tabs are in principle always displayed, even if result data (namely image data) on a specific index card are presently being considered. The always visible tabs of the index cards are consequently particularly suitable for the display of status information, which can be rendered therein as text, symbols and/or graphics, for example, that can also be emphasized (for example it can be colored and/or blinking) depending on the specific value of the status information. A display of the status information that is particularly clear, easy to survey, and simple to realize is therefore possible, simultaneously with result data.

Other embodiments are also conceivable, such as a special, always visible status window, a status bar in an observation window for the result data and the like. In each case it is advantageous if—generally given a change of the status information and/or given a specific change and/or a specific content of the status information—the corresponding status information is shown with emphasis, for example with blinking and/or in color. Changes—or at least significant changes—of the status information are then clearly emphasized, in particular those that could determine a decision of the observing person.

There is also often the desire to be able to use an optimally simple communication path, particularly when a decision has been made (a new or additional acquisition of image data in a medical context, for example) or if there are questions on the part of a person implementing the process. Although it is known to operate via telephone or by direct speaking in this regard, this is not optimal in terms of the time cost and efficiency.

In order to address this problem, in a preferred embodiment of the invention the status information includes a desire for assessment of result data transmitted to the second computer and/or a request for consultation with the person implementing the process is used. This thus means that the status information can be expanded if and when the need exists on the part of a user at the first computer to conduct a consultation or to receive an assessment. In the medical case, this means that, for example, with the status information for assessment of image data of questionable quality, a person conducting the image acquisition can express just as other inquiries can be posed, for example whether additional image data should be acquired, specific additional means (a local coil, for example) should be used, and the like. Because it is an addendum to the status information, the person working at the second computer consequently also receives a corresponding display and is therefore informed about the desire for communication.

It is advantageous for the status information pertaining to the desire and/or the request to be determined based on the activation of a control element provided at the first computer. For example, if a process is presently being implemented (ongoing process), an operating element that adds the desire and/or the request to the status information and provides for their determination can be displayed or physically provided at the first computer. This can be a button in a user interface of the first computer. A particularly simple operation and communication of the communication desire is thus possible.

In another embodiment, a computer program designed to exchange input text passages is present in distributed form at the first computer and the second computer. It is consequently proposed to use a computer program—in particular what is known as a chat computer program—in order to actually realize the communication, such that this can also be carried out solely via the first and second computers without speaking and without requiring one person to walk to another room, and without an additional apparatus (in particular a telephone) being necessary. For example, such a chat computer program is described in German Patent Application DE 10 2012 204 767, which is incorporated herein by reference.

The computer program can be invoked and/or a window for communication with the first computer can be openable through an interaction with the indicated status information relating to the request and/or the desire. For example, if the corresponding status information is displayed as a symbol and/or a text and/or a graphic, this presentation of the status information can be selected via a suitable input means (a mouse, for example), in order to directly produce the communication possibility in the form of the computer program (via a click, for example), or to bring the computer program that is already running in the background into the foreground, for example by activation of the focus at a window for communication with the first computer. The desired communication thus can be realized in an intuitive and technically simple manner.

A computer program designed to exchange input text messages can naturally also be used by a user at the second computer when this user would like to transmit inquiries and/or instructions (that can arise based on consideration of the result data) to the first computer, namely to the person implementing the process. For example, if a radiologist assesses images and establishes that he or she would like to have a lesion in the image data examined in more detail through acquisition of additional image data, the radiologist can use the computer program in order to send a suitable text message to the first computer.

In addition to the method, the present invention also concerns a system with a first computer associated with an implementation workstation and a second computer associated with an observation workstation and connected with the first computer via a communication connection, wherein the first computer is designed to transfer result data of a number of processes to the second computer, and the first computer is further designed to determine at least one item of status information indicating the status of a process and to transfer the status information to the second computer, and the second computer is designed to display the status information simultaneously with displayed result data of the process and/or another process. All embodiments with regard to the method according to the invention apply analogously to the system according to the invention, such that the advantages of the present invention can also be achieved with this system. The first computer consequently can be associated with a medical image acquisition device (thus is located at an image acquisition workstation) and acquired image data of a patient can be transferred to a finding workstation that includes (or is) the second computer.

The invention also concerns a non-transitory, computer-readable data storage medium encoded with programming instructions that cause the method according to the invention to be implemented at a system of the type according to the invention, consequently a first and second computer. The programming instructions, when the storage medium is loaded in a distributed manner, into the first computer and the second computer cause the steps of the method according to the invention to be executed. For example, the computer program package can be part of a software suite provided for the assessment anyway, or can supplement such a software suite.

### BRIEF DESCRIPTION OF THE DRAWINGS

FIG. 1 schematically illustrates a system according to the invention.

FIG. 2 shows a display at the second computer at a first point in time.

FIG. 3 shows the display at the second computer at a second point in time.

FIG. 4 shows the display at the second computer at a third point in time.

FIG. 5 shows a display at the first computer.

FIG. 6 shows the display at the second computer at a fourth point in time.

FIG. 7 shows the display at the second computer at a fifth point in time.

### DESCRIPTION OF THE PREFERRED EMBODIMENTS

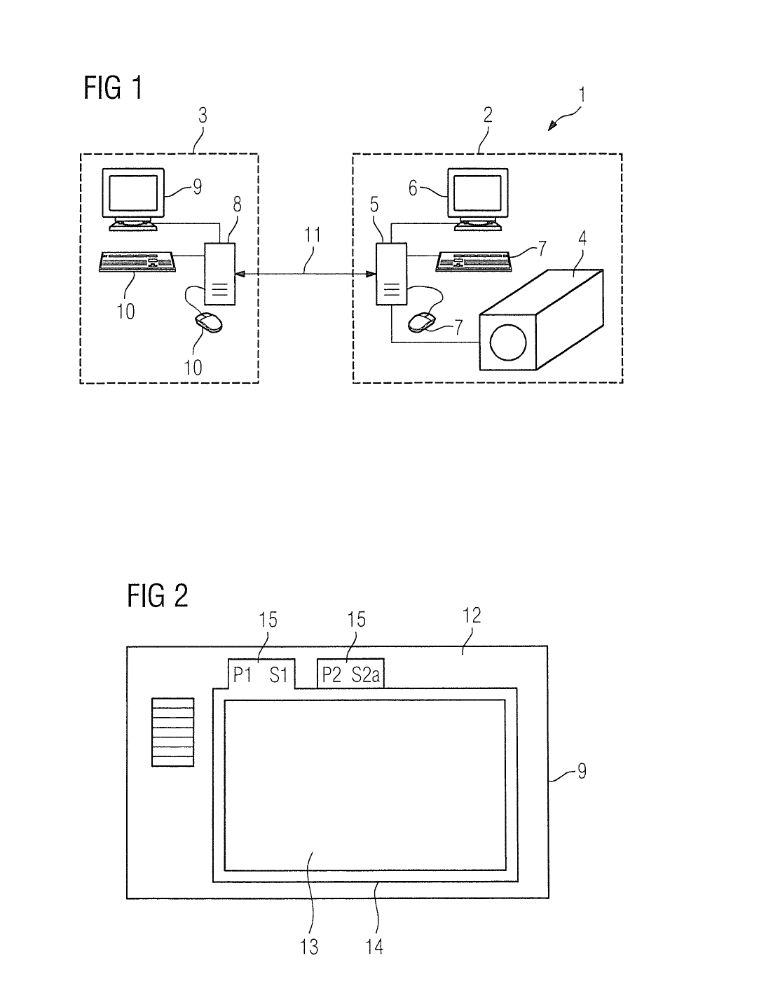

FIG. 1 schematically shows a system 1 according to the invention in the form of a medical image acquisition, wherein a differentiation is made between an image acquisition workstation 2 as an implementation workstation and a finding workstation 3 as an observation workstation. The image acquisition device 4 (which in this embodiment is designed as a magnetic resonance device) is located at the image acquisition workstation 2. This is controlled by a first computer 5 that, as is known, has a display device 6 (here at least a monitor) and at least the input unit 7 (in particular a keyboard and a mouse). While the first computer 5 also acts as a control device of the image acquisition device 4 in the exemplary embodiment, it is also possible for the image acquisition device 4 to have a separate control device or the first computer 5 can be formed by components of such a control device that has other components that suitably communicate with the first computer 5.

An assessor (in particular a radiologist) has the need to assess and evaluate image data (acquired at the image acquisition device 4) of different patients at the finding workstation 3 (a separate room, for example). For this purpose, a second computer 8 is provided at the finding workstation 3, which likewise has a display device 9 (again a monitor) and at least one input unit 10.

In order to be able to view and evaluate image data as result data at the second computer 8, it is connected with the first computer 5 via a communication connection 11. It should be noted that the communication device 11 does not need to be a dedicated communication connection 11 serving only for the communication between the computers 5, 8; rather, the communication device preferably is formed as a network, in particular an intranet.

Suitable computer programs at the computers 5 and 8 (in particular as part of a computer program package according to the invention) enable the implementation of the method according to the invention in the system 1.

A list of patients who should be examined within the time in which a specific assessor is responsible for making assessments is present at the computer 5. Each examination of each patient corresponds to a process that must be monitored and assessed by the assessor at the finding workstation 3. The list is used in order to design a user interface 12 at the display device 9 (see FIG. 2) via which image data 13 (not shown in detail here) of different patients P1, P2 can be considered via index cards 14. The tabs 15 of the index cards 14 include the names or another identification feature of the patients P1, P2, and the corresponding patients (and thus examinations) can be selected via these tabs 15. The user interface 12 can furthermore include a number of items of information, control elements and the like that are not shown in detail for clarity.

The first computer 5 now continuously determines status information with regard to the individual examinations, which status information describes the status of the examinations. While this can be simply “concluded” and “pending” for already concluded examinations (such as for the patient P1 in the present case) and examinations that have not yet begun, the status information with regard to currently implemented examinations is resolved in more detail, particularly for an acquisition of image data that has already occurred, the point in time of the administration of a contrast agent, or the point in time of the ending of the examination. This is discussed in more detail in the following.

For all examinations of the cited list, this status information is transferred to the second computer 8 via the communication connection—at least always when a change of the status information is present—and presented there simultaneously with image data 13. This is accomplished in the exemplary embodiment by the status information (see first FIG. 2) being additionally presented in the tab 15 associated with the respective patients P1, P2. The status information S1 that is shown reads “concluded”, for example, for the already concluded examination of the patient P1. FIG. 2 shows the user interface 12 at a first point in time at which the examination of the patient P2 has started. The status information S2a accordingly now reads “scanning”. Naturally, more patients can typically be provided, and the status information could read “pending” at this point in time for patients Pi that have yet to be examined. From this the assessor can now conclude that no image data are yet present.

The status information generally must not be represented by text; rather, symbols and/or graphics (possibly in addition) are also conceivable. For example, the fact that a scan process is presently running can be represented in detail by a line rotating in a circle of dashed lines, or the like.

As soon as image data from the patient P2 are also present, the status information can change and the altered status information is received and presented by the second computer 8. In addition to the fact that the examination is presently running, the presence of image data can now be indicated, for example via an image data symbol (not shown in detail here). The assessor is then aware that he can select the index card (frequently also designated in other regards as a “tab”) 14 of the patient P2 in order to also discover actual image data there.

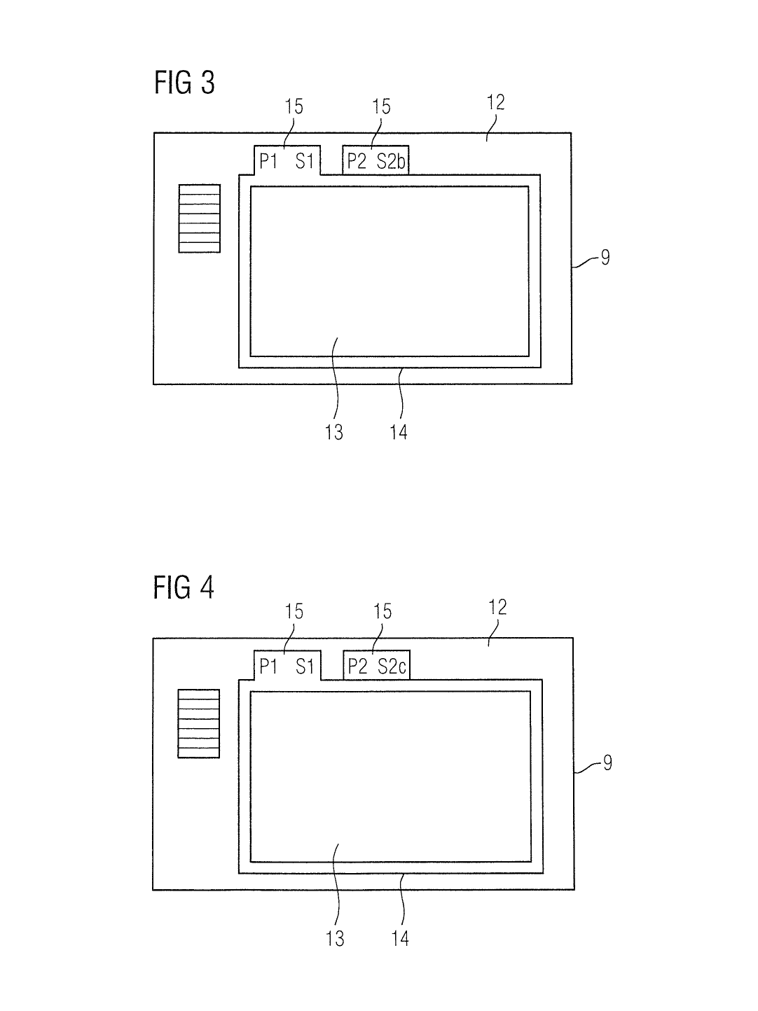

The FIG. 3 shows the user interface 12 at a second, later point in time during the examination of the patient P2. The status information has again been updated at a defined point in time before the administration of a contrast agent, for example after the end of an image data acquisition step. The status information S2b shown here furthermore includes the notification that the examination is presently running (“scanning”); however, it is additionally displayed that the contrast agent administration is planned in 1:30 minutes (for example “Contrast Agent in 1:30”). In the event that he or she would like to repeat an image data acquisition without contrast agent or would like to acquire additional image data without contrast agent, the assessor is now aware that he only still has a defined amount of time in order to communicate this to the person conducting the examination. The corresponding time display thereby correctly counts down as part of the status information S2b.

In order to send a message to the person conducting the examination (and who is located at the first computer 5), the assessor can moreover use a computer program to exchange text messages (a chat program) which is installed at the first computer 5 and the second computer 8. This can be invoked by a suitable control element; it is also conceivable that specific status information enable the computer program for the exchange of text messages, or a corresponding window of this computer program, so as to allow human interaction with the displayed status information, for example the user clicks on this or uses a context menu. This is always advantageous when such decision time periods are indicated; however, an embodiment is also conceivable in which the computer program for exchanging text messages with the first computer 5 can always be invoked or the corresponding communication window can always be displayed by clicking on the indicated status information. It is thus possible for the assessor to transmit instructions and/or comments to the first computer 5, and thus the operator there.

FIG. 4 shows the user interface 12 at a third point in time during the examination of the patient P2. The contrast agent is now administered, which is depicted as part of the status information S2c (for example as “Contrast applied”). However, information is now also already included as to when the examination of the patient P2 will be concluded, which is likewise displayed as a “timer” as this has already been presented with regard to FIG. 3. Here as well, this is in principle a decision time period in which the user must consider whether image data should be acquired again (for example by repeating examination steps) or whether he would even like to acquire additional image data, for example for more precise examination of a lesion.

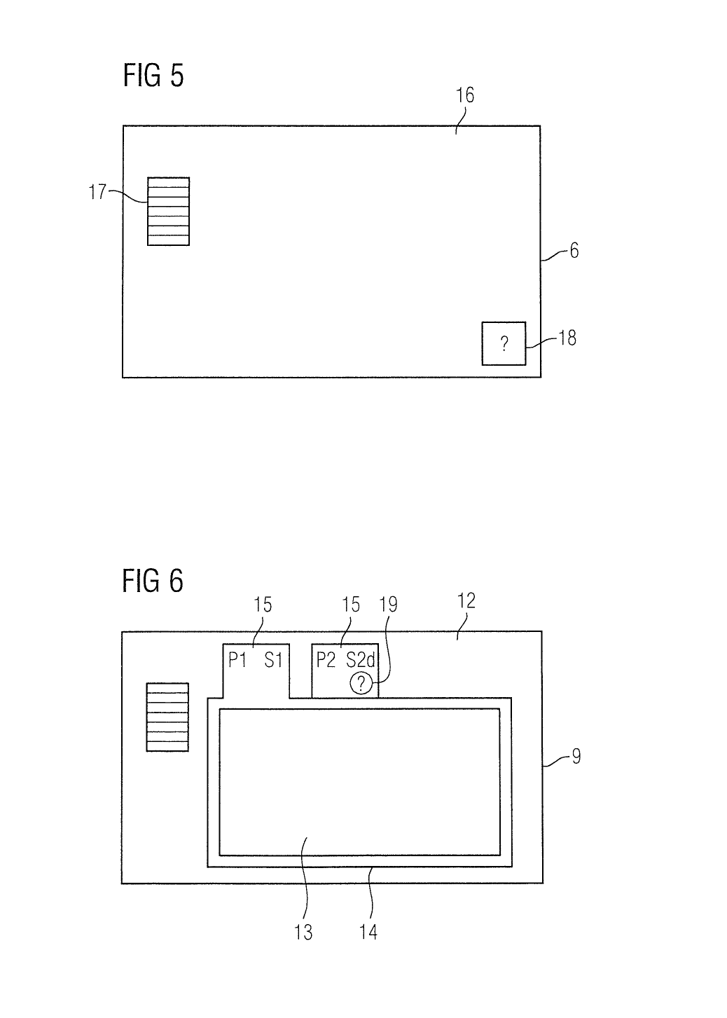

FIG. 5 schematically shows a user interface 16 presented at the display device 6 of the first computer 5, which user interface 16 can include a sequence of steps 17 of the examination. However, part of the user interface 16 is in particular a control element 18 via which the person conducting the examination can add a desire for assessment of image data transmitted to the second computer 8 and/or can add to the status information a request for consultation.

This is now in turn transferred to the second computer 8, wherein now not only the status information S2d indicating the implementation of the examination (as shown in FIG. 6) but additionally a symbol 19 which indicates the request or, respectively, the desire is presented there. This inquiry is presented with particular emphasis, for example via a corresponding coloration and/or a blinking presentation. It is noted that such an emphasis can be provided given any change of the status information, for example by blinking the corresponding tab 15 until this has been selected or the like.

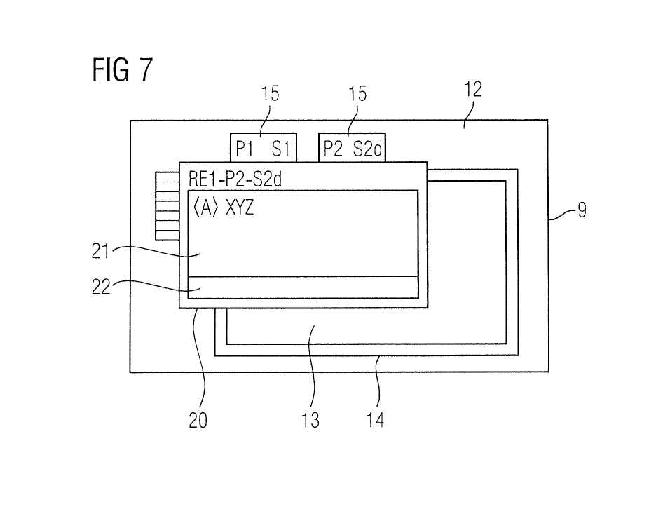

If it is not provided anyway that an interaction with the shown status information leads to the invocation of the computer program to exchange text messages, or invocation of the corresponding communication window with the first computer 5 if the computer program for exchanging text messages is already active, in every case it is now provided that the computer program for exchanging text messages or the communication window is invoked upon interaction with the symbol 19 (in particular a click on the symbol 19). The resulting situation is presented in FIG. 7.

There a communication window 20 of the computer program for exchanging text messages is now opened which displays in a status line the communication partner (here (RE1)), the patient P2 examined there and possibly also the status information S2d. Already exchanged text messages are visible in a message region 21. Text messages can be composed via an input line 22. A corresponding inquiry by the person implementing the examination can thus be answered; however, it is also possible to relay instructions, assessments and the like at the request of the assessor himself.

DE 10 2012 204 767 provides further embodiments with regard to the computer program for exchanging text messages.

Although modifications and changes may be suggested by those skilled in the art, it is the intention of the inventor to embody within the patent warranted hereon all changes and modifications as reasonably and properly come within the scope of his contribution to the art.

We claim as our invention:

1. A method to operate a system comprising a first computer associated with an implementation workstation and a second computer associated with an observation workstation and in communication with said first computer via an electronic communication connection, comprising:
at a site of said first computer, generating result data for a plurality of processes conducted at the site at which said first computer is located;
via said communication connection, transferring said result data from said first computer to said second computer;
at the site of said first computer, generating, for each of said processes, status information that indicates an individual status of the respective processes;
transferring said status information via said communication connection from said first computer to said second computer together with said result data; and
at said second computer, displaying said result data simultaneously with said status information and a visual indication that associates the status information with the respective process for which the status information indicates the status.

2. A method as claimed in claim 1 comprising, at said site of said first computer, generating said result data with an apparatus that comprises a control device in communication with said first computer at said site of said first computer, and generating said status information in at least one of said first computer and said control device.

3. A method as claimed in claim 1 comprising generating said status information continuously at said site of said first computer, and transferring said status information from said first computer to said second computer via said communication connection at least upon an occurrence of a change of said status information.

4. A method as claimed in claim 1 wherein each of said processes comprises multiple steps, and generating said status information as each of said multiple steps is currently executed.

5. A method as claimed in claim 1 wherein execution of at least one of said processes requires an action to be taken at said second computer, and transferring said status information for said at least one of said processes from said first computer to said second computer via said communication connection at a time that is appropriate for said action.

6. A method as claimed in claim 1 comprising:
generating said result data as medical image data for a patient by operating a medical image data acquisition device at said site of said first computer;
configuring said first computer as an image acquisition workstation that participates in controlling said image data acquisition apparatus; and
configuring said observation workstation as a medical finding workstation to allow a user at said second computer to make diagnostic medical findings based on said image data of said patient.

7. A method as claimed in claim 6 comprising providing said first computer with a list of patients to be examined, within a predetermined time period, using said medical image data acquisition apparatus, and generating said status information individually for each patient in said list.

8. A method as claimed in claim 7 comprising generating said status information for each patient to identify a point in time for beginning the examination of that respective patient with said medical image data acquisition apparatus, and an indication that the examination of the respective patient with said medical image data acquisition apparatus is currently ongoing.

9. A method as claimed in claim 8 comprising indicating, in said status information, at least one step or event in the examination of the respective patient to which the status information pertains.

10. A method as claimed in claim 9 comprising indicating, in said status information, at least one of a time at which a contrast agent is administered to the respective patient, and occurrence of an end of the examination of the respective patient with said medical image data acquisition apparatus.

11. A method as claimed in claim 1 comprising, at said second computer, displaying said result data and said status information at a user interface comprising index cards respectively for the plurality of processes, with each index card comprising a tab in which the status information is displayed for the respective process displayed in the respective index card.

12. A method as claimed in claim 1 comprising operating said first computer with a first human operator and operating said second computer with a second human operator, and comprising including, in the individual status information for a respective process, a request from said first human operator to said second human operator for said second human operator to perform at least one of an assessment of the result data and a consultation with said first human operator.

13. A method as claimed in claim 12 comprising including said request in said status information by operation of a specified control element at said first computer.

14. A method as claimed in claim 12 comprising configuring each of said first and second computers for exchanging, the as said communication connection, text messages, and formulating said request as a text message.

15. A method as claimed in claim 14 comprising configuring said first and second computers to open a window to establish communication by exchange of text messages via said communication connection.

16. A computerized information exchange system, comprising:
a first computer located at a site of an implementation workstation;
a second computer located at a site removed from said site of said first computer, associated with an observation workstation;
an electronic communication connection allowing communication between said first computer and said second computer;
said first computer being provided with result data, generated at a site of said first computer, for a plurality of processes conducted at the site at which said first computer is located;
said first computer being configured to transfer said result data from said first computer to said second computer via said communication connection;
said first computer also being provided with status information, generated at the site of said first computer for each of said processes, said status information indicating an individual status of the respective processes;
said first computer being configured to transfer said status information via said communication connection from said first computer to said second computer together with said result data; and
said second computer being configured to display said result data simultaneously with said status information and a visual indication that associates the status information with the respective process for which the status information indicates the status.

17. A non-transitory, computer-readable data storage medium encoded with programming instructions, said storage medium being loaded in a distributive manner in a first computer and a second computer that have an electronic communication connection there between, said programming information causing:
said first computer to receive result data for a plurality of processes conducted at the site at which said first computer is located;
said first computer to transfer said result data from said first computer to said second computer via said communication connection;
said first computer to be provided with status information, generated at the site of said first computer for each of said processes, that indicates an individual status of the respective processes;
said first computer to transfer said status information via said communication connection from said first computer to said second computer together with said result data; and
said second computer to display said result data simultaneously with said status information and a visual indication that associates the status information with the respective process for which the status information indicates the status.
